(19) United States
(12) Patent Application Publication
(10) Pub. No.: US 2025/0384011 A1
(43) Pub. Date: Dec. 18, 2025

(54) DATA COMPRESSION TECHNOLOGIES

(71) Applicant: Intel Corporation, Santa Clara, CA (US)

(72) Inventors: Fei Z. WANG, Shannon (IE); Giovanni CABIDDU, Shannon (IE); Laurent COQUEREL, Limerick (IE)

(21) Appl. No.: 19/324,945

(22) Filed: Sep. 10, 2025

(51) Int. Cl. G06F 16/174; G06F 9/50

(52) U.S. Cl. CPC G06F 16/1744; G06F 9/5005; G06F 2209/509

(57) ABSTRACT

Examples described herein relate to an accelerator configured to: based on receipt of a request from a requester to offload performance of data compression to an accelerator, compress data and generate a compressed data frame consistent with a data compression format comprising a header and footer.

A processor can offload cryptographic and compression tasks to accelerator devices to reduce computational loads on the processor. To perform data compression to reduce a size of data, accelerator devices replace patterns or sequences of data with shorter representations. Dictionaries store patterns or sequences of data and corresponding shorter representations or code. As the accelerator processes the data, the accelerator continuously scans for sequences that match entries in the dictionary and when a match is found, the accelerator outputs the corresponding code instead of the longer data sequence. The extent of data compression depends on the extent to which the dictionary identifies data sequences that are replaced with shorter representations or codes.

### BRIEF DESCRIPTION OF THE DRAWINGS

FIG. 1 depicts an example system.

FIG. 2A depicts an example compressor.

FIG. 2B depicts an example decompressor.

FIG. 3 depicts an example of a dictionary creation and data compression mode.

FIG. 4 shows an example compression system.

FIG. 5 depicts an example process.

FIG. 6 depicts an example accelerator.

FIG. 7 depicts an example system.

### DETAILED DESCRIPTION

Accelerators compress data according to data compression standards such as Zstandard, as described at least in Internet Engineering Task Force (IETF) “Zstandard Compression and the ‘application/zstd’ Media Type” (February 2021). Zstandard (ZSTD) specifies a format of a frame with frame header, compressed data blocks, and a frame footer. In some cases, an accelerator compresses data and generates sequences. A sequence can include a combination of literal length (e.g., number of bytes that are copied directly (not matched)), match offset (e.g., how far back to look in the history (or dictionary) for a match), and match length (e.g., how many bytes to copy from the match) but a processor performs post processing to encode the sequences and provide the frame header and/or the frame footer to generate Zstandard compatible frames. The post processing can transpose the sequences to Zstandard sequences.

Various examples include an accelerator configured to generate a compressed data frame with a frame header, compressed data blocks, and frame footer according to a compression standard, including Zstandard, or others. Some implementations of the accelerator generate a compressed data frame and may not post-process the sequence by a processor-executed software. Various examples can reduce latency to generate a compressed data sequence as a processor-executed application may not add the frame header and footer to the data sequence. Accordingly, a customer's application that requests compression or decompression of data need not include operations to translate intermediate format data to a second compression standard (e.g., zstandard).

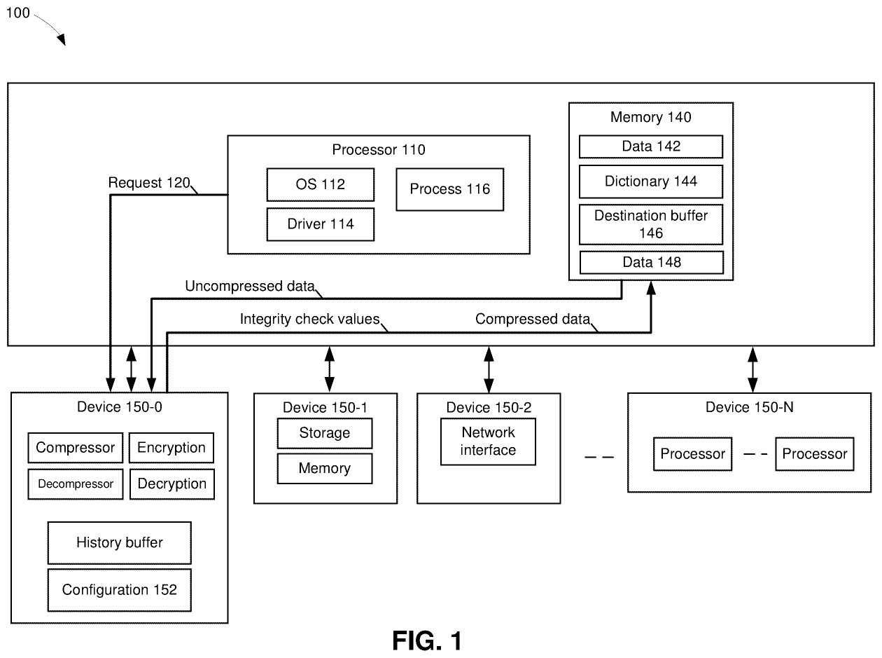

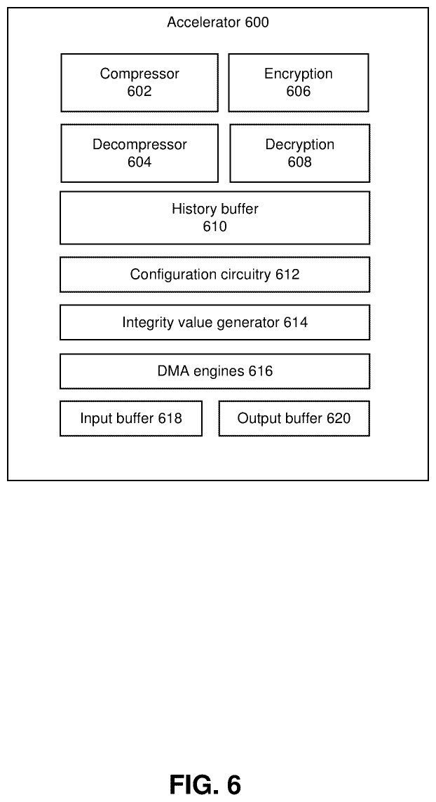

FIG. 1 depicts an example system. System 100 can include processor 110, memory 130, one or more of devices 150-0 to 150-N, where N is an integer, and other circuitry and software described at least with respect to FIGS. 6 and/or 7. In some examples, system 100 can be implemented in a semiconductor package. The semiconductor package can include metal, plastic, glass, and/or ceramic casing that covers and encapsulates one or more semiconductor devices or integrated circuits (e.g., processor 110, memory 140, or one or more of devices 150-0 to 150-N) and provides communications within or among the one or more semiconductor devices or integrated circuits.

Processor 110 can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Accelerator cores, slices, and/or cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

In some examples, processor-executed operating system (OS) 112 or driver 114 can advertise capability of one or more of devices 150-0 to 150-N to compress data and generate a compressed data frame with a frame header, compressed data blocks, and frame footer according to a compression standard. For example, OS 112 can call an application programming interface (API) or issue a configuration to configure one or more of devices 150-0 to 150-N to compress data and generate a compressed data frame with a frame header, compressed data blocks, and frame footer according to a compression standard.

Processor 110 can execute processes 116 that can request packet processing, packet transmission, data compression, data decompression, data encryption, data decryption, data copying, or other operations to be performed by one or more of devices 150-0 to 150-N. Processes 116 can include one or more of: an application, process, thread, a virtual machine (VM), micro VM, container, microservice, virtual function (VF), virtual device, or other virtualized execution environment.

For example, one or more of processes 116 can issue request 120 to one or more of devices 150-0 to 150-N to compress data and generate a compressed data frame with a frame header, compressed data blocks, and frame footer according to a compression standard by specifying configuration 152. Request 120 can specify one or more of: starting address of data 142 in memory 140, size of allocated destination buffer size 146 to avoid overflow, whether to compress data and verify compression of data based on a security code, whether to create a dictionary, or others.

One or more of devices 150-0 to 150-N can perform operations offloaded from processor 110. Devices 150-0 to 150-N can include one or more of: an accelerator, a memory device, a memory controller, a storage device, a storage controller, a network interface device, or other circuitry, such as circuitry described with respect to FIGS. 6 and/or 7. A network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

One or more of devices 150-0 to 150-N can perform data compression or decompression. In some cases, lossless or lossy compression and decompression schemes can be performed. Various compression and decompression schemes are available to be performed such as but not limited to Lempel Ziv (LZ) family of compression schemes including LZ77, LZ78, LZ4, Zstandard (ZSTD), DEFLATE, GZIP, XP10, and Snappy standards and derivatives, among others.

In some examples, one or more of devices 150-0 to 150-N can compresses data 142 to create a frame consistent with Zstandard. A Zstandard frame can include a Literals Section and a Sequences Section for decompression, particularly the sequences which describe data copies and literal extractions.

In some examples, one or more of devices 150-0 to 150-N can compress data 142 and verify compressed data 142 prior to storage in destination buffer 146. One or more of devices 150-0 to 150-N can generate security codes for input and output buffers and provides access to process to security codes for data 142 stored in an input buffer and content of destination buffer 146 and utilize a compression library to verify input and output buffers. Various examples of security codes include at least a checksum, cyclic redundancy check (CRC), hash, or others.

In some examples, one or more of devices 150-0 to 150-N may not support overflow buffer for compressed data. One or more of processes 116 can configure one or more of devices 150-0 to 150-N to indicate size of allocate destination buffer size to avoid overflow. One or more of processes 116 can access a library to calculate a size of a destination buffer.

One or more of processes 116 can configure one or more of devices 150-0 to 150-N to perform dictionary creation. Dictionary creation can include a fixed function or a programmable offload engine processor analyzing input data with a match string. The match string can be one more characters in length (e.g., 3 bytes long as an example). The matching string can be compared to the input data as a sliding window. When the string is matched with the input data, a frequency counter can be incremented and a table is built that combines matching strings and frequencies. The dictionary would be made of the matching strings with the highest frequencies.

For decompression, to provide additional data integrity information, a device that is to perform data compression or decompression (e.g., device 150-0) can generate integrity check values on data prior to data compression (e.g., a copy of data 142 after copying from memory 140) and after compression of the data (e.g., a copy of data 148 prior to storage in memory 140) and provide the integrity check values to process 116. Process 116 can compare the integrity check values provided by the device with integrity check values generated on data 142 and compressed data 148 to verify that uncompressed data or compressed data was not modified while being processed by device 150-0.

One or more of devices 150-0 to 150-N can include Intel® QuickAssist Technology (Intel® QAT). An example QAT is described at least with respect to FIG. 6. One or more of devices 150-0 to 150-N can include accelerator cores, which can be organized into slices. A slice can include a logical partition of accelerator core and a slice can be configured to handle specific types of workloads, such as cryptographic operations (e.g., encryption, decryption) or data compression. QAT can perform offloaded compression and decompression of data by applying one of multiple different compression formats (e.g., zstandard, DEFLATE, or others).

Processor 110 can access one or more of devices 150-0 to 150-N by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processor 110, memory 140, devices 150-0 to 150-N, or others) can be enclosed in one or more semiconductor packages. A semiconductor package can include metal, plastic, glass, and/or ceramic casing that encompass and provide communications within or among one or more semiconductor devices or integrated circuits.

In some examples, system 100 can be implemented as part of a system-on-a-chip (SoC) or system in package (SiP). Various examples of system 100 can be implemented as a discrete device, in a die, in a chip, on a die or chip mounted to a circuit board, in a package, or between multiple packages, in a server, in a CPU socket, or among multiple servers.

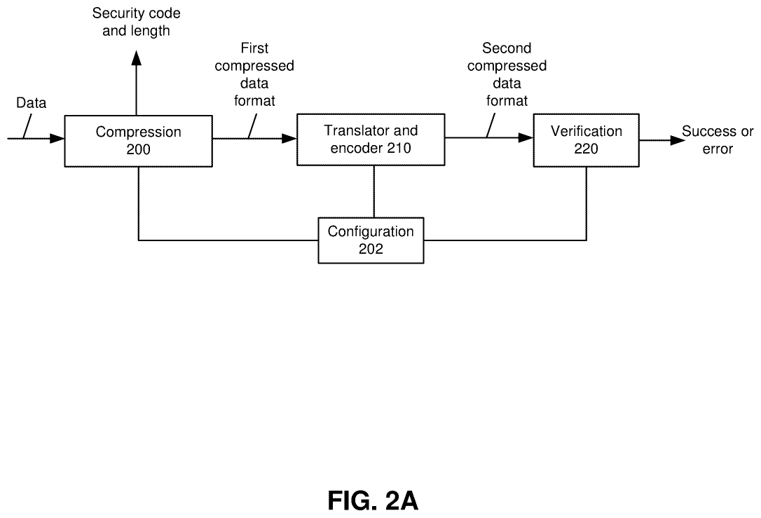

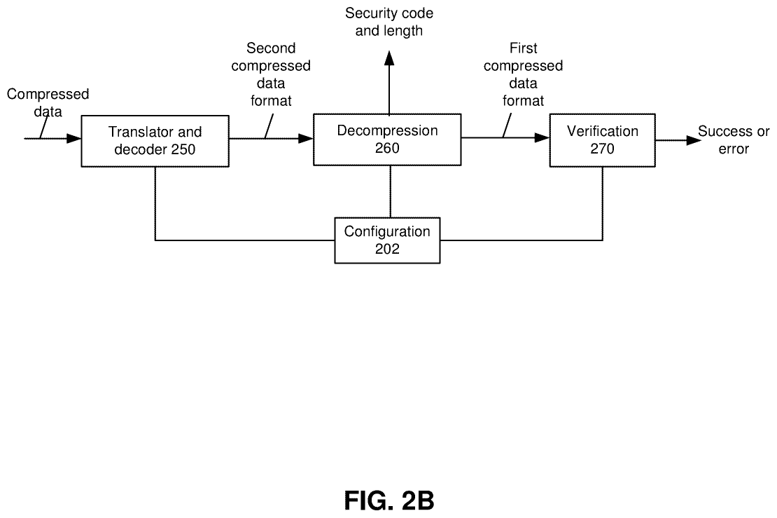

FIG. 2A depicts an example accelerator. Compression circuitry 200 can process cleartext data (e.g., data 142) and output compressed payload in a first format specified by configuration 202 (e.g., configuration 152). Compression circuitry 200 can read cleartext data and generate LZ77 data, which can include literals and tokens. A literal can include symbols that could be compressed whereas a token can include a representation of a sequence of characters. Compression circuitry 200 can be configured to support different compression algorithms, support different history buffer sizes, and performance targets. If an error is encountered during compression, compression circuitry 200 can raise a notification to the requesting process (e.g., process 116).

Translator and encoder circuitry 210 can encode the output from compression circuitry 200 into compressed payload of a second format based on configuration 202 (e.g., configuration 152). For example, translator and encoder circuitry 210 can apply Huffman encoding, Finite State Entropy (FSE) encoding, arithmetic coding, Lempel-Ziv-Welch (LZW), Run-Length Encoding (RLE), or other encoding to encode the output from translator and encoder circuitry 210. In some examples, translator and encoder circuitry 210 can generate compressed data compliant with the zstandard specification. During zstandard compression, translator and encoder circuitry 210 can perform the entropy encoding of the intermediate LZ77 payload and produces compressed output that is compliant to the zstandard specification. However, based on configuration 202, translator and encoder circuitry 210 can generate compressed data consistent with other standards such as DEFLATE, GZIP, XP10, or others.

Verification circuitry 220 can perform verification of data by decompressing the compressed data; determining a length of decompressed data; determining a security code on the decompressed data; comparing a length of data prior to compression with a length of the data generated from decompressing compressed data; comparing a security code of the data prior to compression with a security code generated on the decompressed compressed data; and for matches of both length and security code indicating successful compression, whereas for a mismatch of the length or security code, indicating an error in compression.

While examples are described with respect to compression, examples can perform decompression. FIG. 2B depicts an example accelerator that can perform decompression. Translator and decoder circuitry 250 can apply Huffman decoding, Finite State Entropy (FSE) decoding, or other decoding to decode compressed data (e.g., data 148). For example, translator and decoder circuitry 250 can generate LZ77 compressed data from zstandard compressed data. Decompression circuitry 260 can decompress data and output decompressed payload based on configuration 202 (e.g., configuration 152). For example, decompression circuitry 260 can decompress LZ77 data, which can include literals and tokens, and provide cleartext. If an error is encountered during decompression, decompression circuitry 260 can raise a notification to the requesting process (e.g., process 116). Other data decompression standards can be used.

Verification circuitry 270 can perform verification of data by determining a security code on the decompressed data; determining a length of the decompressed data; comparing a length of data prior to compression with a length of the decompressed data; comparing a security code of the data prior to compression with a security code generated on the decompressed data; and for matches of both length and security code indicating successful decompression, whereas for a mismatch of the length or security code, indicating an error in decompression.

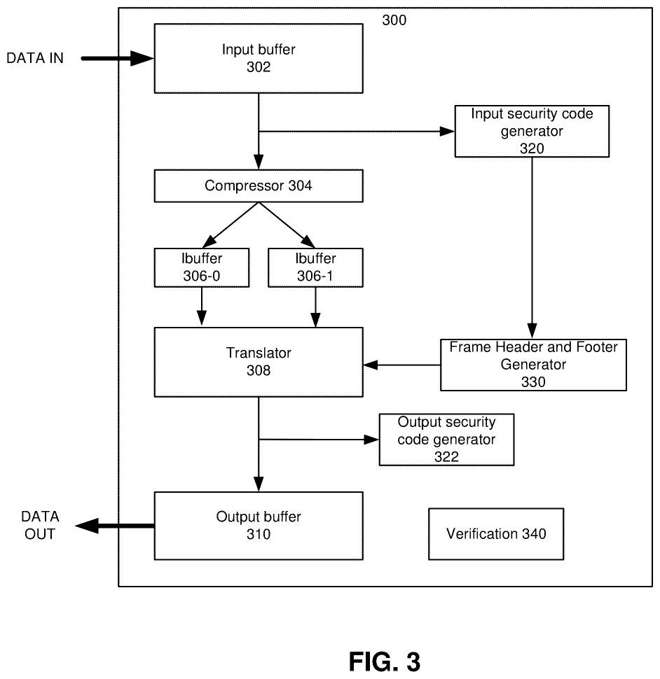

FIG. 3 depicts an example system. Input buffer 302 stores input data (e.g., data 142) prior to compression. Input security code generator 320 generates security codes on input data prior to compression. Security codes can include checksum, cyclic redundancy check (CRC), hash, or other calculations. Compressor 304 can compress data stored in buffer 302 into sequences. Compressor 304 can write the literals of compressed data to a head of an Ibuffer and the encoded sequences to a tail of the Ibuffer. In some examples, Compressor 304 can toggle storage of the compressed data into ping-pong buffers (Ibuffers) 306-0 and 306-1. For example, during zstandard compression, compressor 304 can write different intermediate LZ77 blocks into different Ibuffers so that translator 308 can process data from one Ibuffer while compressor 304 writes to another Ibuffer.

Translator 308 can convert compressed data of a first format by performance of encoding of the data of the first format to generate zstandard compressed blocks, dynamic deflate, LZ4, GZIP, XP10, or other formats. Encoding of data can include Huffman encoding, FSE encoding, or others. As a block size is not known until the entire block is compressed, creation of the block header occurs when or after the entire block is compressed. The compressed block is staged in output buffer 310 of translator 308. Frame header and footer generator 330 can generate the block header and footer when or after the entire block is compressed. For zstandard compression, frame header and footer generator 330 can insert a 3-byte block header at the head of the compressed block and insert a block footer at the end of the zstandard block.

A size of output buffer 310 can be specified by a requester process (e.g., process 116). For example, process 116 can set a size of output buffer 310 to reduce a likelihood of overflow of buffer 310 when storing compressed data.

To provide additional data integrity information, input security code generator 320 can generate security codes on the input (cleartext) and output security code generator 322 generates a security code on output data stored in output buffer 310 (compressed data). Verification circuitry 340 can verify data compression integrity by: decompressing data, comparing a calculated security code on the decompressed data with the security code generated by input security code generator 320. Verification circuitry 340 can compare the security code generated on cleartext from decompression of compressed data with original security code generated on cleartext before data compression, and a length of cleartext after decompression of compressed data compared to a length of cleartext processed by compressor 304. For matches of security codes and lengths, then accelerator 300 can provide compressed data in destination buffer 146 for access by a process. For mismatches of security codes or lengths, then accelerator 300 may not return data in destination buffer 146. Verification circuitry 340 can also indicate a status of the data integrity check (e.g., success or failure).

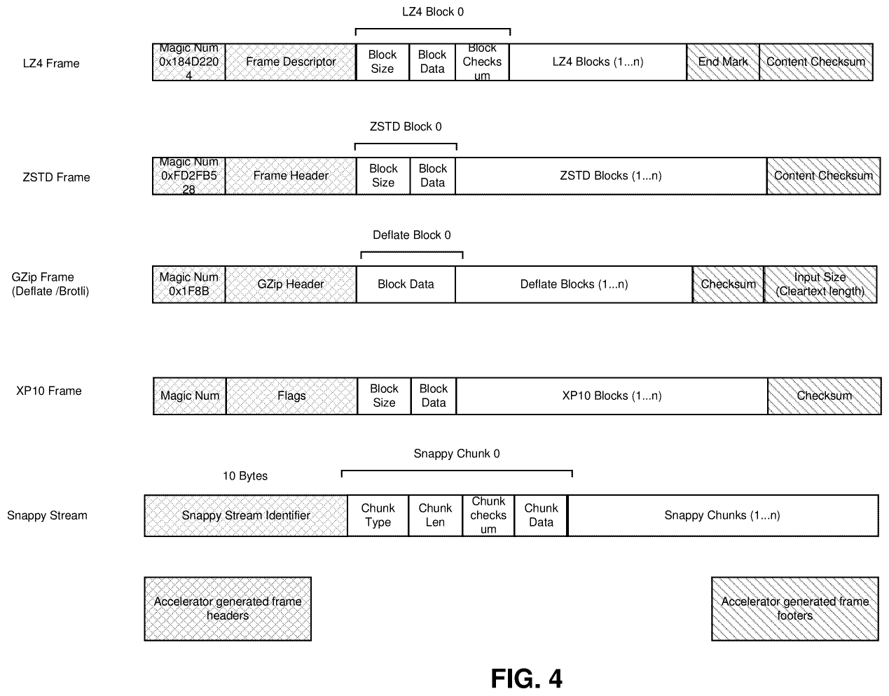

FIG. 4 shows an examples of frame formats. For example, LZ4, ZSTD, Gzip, XP10, and Snappy frame formats are depicted. An accelerator can compress data as blocks and create and insert frame headers and footers into compressed data frames.

For example, an LZ4 frame can include a frame header that includes a 4 byte magic number (Magic Num) with value of 0x184D2204 and a frame descriptor having a length of 3-15 bytes. A frame descriptor can include a flag, a Block Dependency (BD) field, content size, dictionary ID, and an indicator of use of high compression (HC). For example, an LZ4 frame can include a frame footer that includes a 4 byte end mark and 0-4 byte content checksum.

For example, a ZSTD frame can include a 4 byte magic number (Magic Num) with a value of 0xFD2FB528 and a frame header having a length of 2-14 bytes. A frame header can include a 1 byte frame header descriptor, a 0-1 byte window descriptor, a 0-4 byte dictionary ID, and a 0-8 byte frame content size field. For example, a ZSTD frame can include a 32-bit checksum. A checksum can be a result of a xxh64 ( ) hash function digesting the decoded data as input and a seed of zero.

For example, a GZIP frame can include a frame header and a frame footer. A frame header can include a magic number (Magic Num) with a value of 0x1F8B. A frame footer can include a CRC-32 checksum and input size (e.g., a length of cleartext data).

For example, a Snappy stream can include a frame header. A frame header can be 4 bytes and indicate a length of the Snappy stream. The 4 byte header is not included in the length.

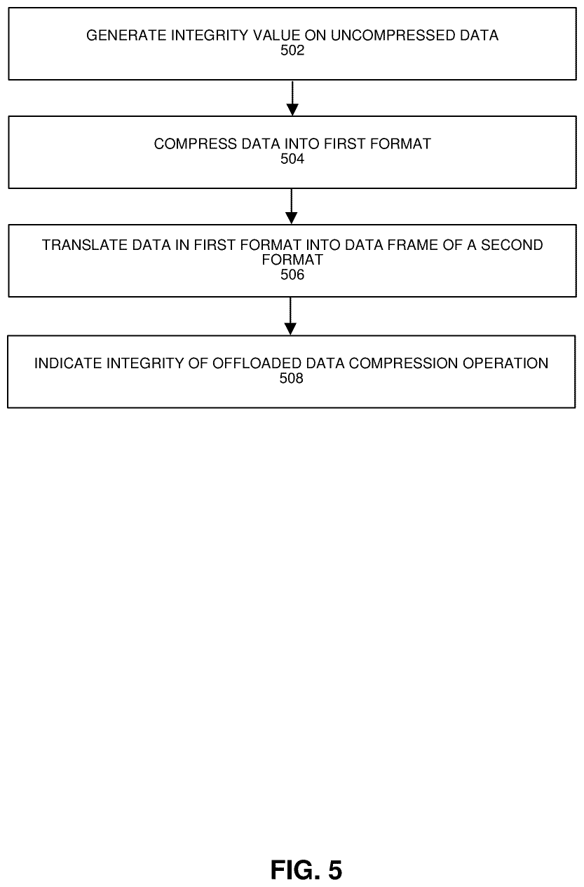

FIG. 5 depicts an example process. The process can be performed by an accelerator to perform offloaded generation of a compressed data frame with header and/or footer according a particular standard. At 502, generate integrity code on data prior to compression by an accelerator. For example, the integrity code can be calculated on the data after copying of the data to a buffer accessible by the accelerator. In addition, a length of the data prior to compression by the accelerator can be determined. At 504, perform, by compression circuitry, compression of data to generate data in a first format. For example, the first format can include compressed data sequences (e.g., literal length, match offset, and match length), but not a compressed data header or footer. At 506, perform, by translation circuitry, encoding of the compressed data to generate compressed data in a second format. Translation circuitry can encode data of the first format, generate a header and/or footer of the encoded compressed data sequence based on the encoded data, and include the encoded compressed data sequence and header and/or footer into a frame of the second format. For example, the encoding and header and footer format can be consistent with ZSTD, Gzip, XP10, Snappy, or other compression standards.

At 508, a check can be performed to integrity of compressed data. For example, to perform a check of integrity of compressed data, the accelerator can: decompress the compressed data frame; generate an integrity value on the decompressed data and determine a length of the decompressed data; compare the generated integrity value and determined length against an integrity value calculated on the data prior to compression and the length of the data determined prior to compression. Based on matching of the integrity values and the length values, an indication can be provided to a process that offloaded performance of compressing data, a driver, or operating system that the data was successfully compressed and the compressed data can be stored into a buffer for access by the process. Based on non-matching of the integrity values or the length values, an indication can be provided of an error in compressing the data to a process that offloaded performance of compressing data, a driver, or operating system.

FIG. 6 depicts an example accelerator. Accelerator 600 can utilize compressor 602 to compress clear text data into a format specified by configuration circuitry 612 or perform data decompression 604 on data in a format specified by configuration circuitry 612 to clear text. Various examples of compression and decompression standards include at least Lempel Ziv (LZ) family of compression schemes including LZ77, LZ78, LZ4, Zstandard (ZSTD), DEFLATE, GZIP, XP10, and Snappy standards. To compress data, compressor 602 can store a dictionary into history buffer 610 to identify strings of characters to replace in data. Integrity value generator 614 can generate a security code on a portion of a dictionary or data. A security code can include a cyclic redundancy check (CRC), hash calculation, or checksum. Accelerator 600 can utilize encryption 606 to encrypt cleartext or compressed data based on a specification in configuration 612. Accelerator 600 can utilize decryption 608 to decrypt data based on a specification in configuration 612. Configuration 612 can specify a standard of data encryption/decryption, including at least Triple Data Encryption Standard (3DES), Advanced Encryption Standard (AES), Digital Signature Algorithm (DSA), Rivest-Shamir-Adleman (RSA) algorithm, Elliptic Curve Digital Signature Algorithm (ECDSA), Elliptic Curve Cryptography (ECC), or others. Integrity value generator 614 can generate security codes (e.g., checksum, CRC values, or others) on cleartext or compressed data. Direct memory access (DMA) engines 616 can access data from memory (e.g., memory 140) and copy data into input buffer 618 based on a command from a process or copy data from output buffer 620 to memory (e.g., memory 140). Input buffer 618 can store data that is to be compressed, decompressed, encrypted, or decrypted. Output buffer 620 can store data that was compressed, decompressed, encrypted, or decrypted.

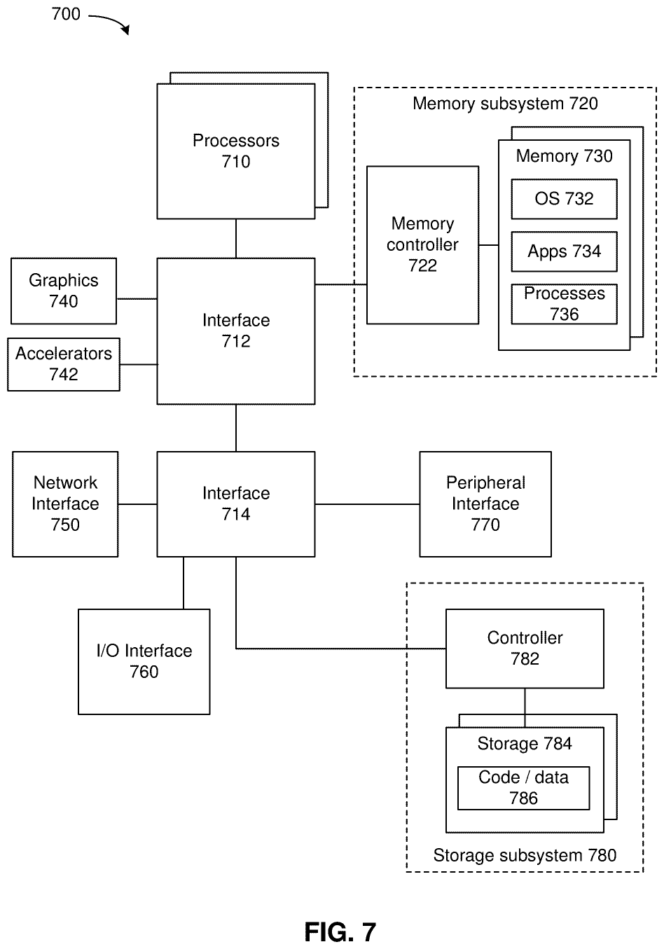

FIG. 7 depicts a system. The system can use examples to compress data and generate a compressed data frame with a frame header, compressed data blocks, and frame footer according to a compression standard, as described herein. In some examples, processor 710, graphics 740, one or more of accelerators 742, and/or network interface 750 can generate a dictionary or generate a dictionary and perform data compression, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die.

Accelerators 742 can be a fixed function or programmable offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as static random-access memory (SRAM), dynamic random-access memory (DRAM), or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 732 or driver can advertise capability of at least one of accelerators 742 to compress data and generate a compressed data frame with a frame header, compressed data blocks, and frame footer according to a compression standard, as described herein. In some examples, OS 732 or driver can enable or disable use at least one of accelerators 742 to compress data and generate a compressed data frame with a frame header, compressed data blocks, and frame footer according to a compression standard.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. In some examples, network interface 750 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 750 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDAR, NVIDIA® DOCATM, Data Plane Development Kit (DPDK), OpenDataPlane (ODP), Infrastructure Programmer Development Kit (IPDK), x86 compatible executable binaries or other executable binaries, or others.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. A non-volatile memory (NVM) device is a memory whose state is determinate even if power is interrupted to the device.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more later examples and includes an apparatus that includes: an interface and a circuitry, coupled to the interface, to: based on receipt of a request from a requester to offload performance of data compression to an accelerator, compress data, generate a header for the compressed data, generate a footer for the compressed data, and generate a compressed data frame consistent with a data compression format comprising the header and footer.

Example 2 includes one or more former or later examples, wherein to compress data, the circuitry is to compress data into a first format and generate the compressed data based on the compressed data in the first format.

Example 3 includes one or more former or later examples, wherein the circuitry is to verify the compressed data prior to identification of compressed data to the requester based on integrity check values.

Example 4 includes one or more former or later examples, wherein the circuitry is to: receive the data to be compressed into a first buffer, generate a first integrity check value on the data in the first buffer, store the compressed data into a second buffer, generate a second integrity check value on the compressed data in the second buffer, and provide access to the first integrity check and the second integrity check to the requester for the requester to verify integrity of the compressed data.

Example 5 includes one or more former or later examples, wherein the circuitry is to: configure a size of a buffer to store the compressed data based on a configuration from the requester.

Example 6 includes one or more former or later examples, wherein the data compression format comprises one or more of: zstandard, LZ77, LZ78, LZ4, DEFLATE, GZIP, XP10, or Snappy.

Example 7 includes one or more former or later examples, wherein the accelerator is accessible by a processor via device interface and wherein the accelerator comprises one or more of: a field programmable gate array (FPGA) or an application specific integrated circuit (ASIC).

Example 8 includes one or more former or later examples, and includes at least one non-transitory computer-readable medium, comprising instructions stored thereon, that if executed by one or more processors, cause the one or more processors to: configure an accelerator to: perform an offloaded data compression operation by: compressing data and generating a compressed data frame consistent with a data compression format comprising a header and footer.

Example 9 includes one or more former or later examples, wherein to compress data, the accelerator is to compress data into a first format and generate the compressed data based on the compressed data in the first format.

Example 10 includes one or more former or later examples, wherein the first format comprises a literal length, match offset, and match length.

Example 11 includes one or more former or later examples, and includes instructions stored thereon, that if executed by one or more processors, cause the one or more processors to: configure the accelerator to verify the compressed data prior to identification of compressed data to a requester of the offloaded data compression operation.

Example 12 includes one or more former or later examples, and includes instructions stored thereon, that if executed by one or more processors, cause the one or more processors to: configure the accelerator to: receive the data to be compressed into a first buffer, generate a first integrity check value on the data in the first buffer, store the compressed data into a second buffer, generate a second integrity check value on the compressed data in the second buffer, and provide access to the first integrity check and the second integrity check to a requester of the offloaded data compression operation for the requester to verify integrity of the compressed data.

Example 13 includes one or more former or later examples, and includes instructions stored thereon, that if executed by one or more processors, cause the one or more processors to: configure the accelerator to: configure a size of a buffer to store the compressed data based on a configuration from a requester of the offloaded data compression operation.

Example 14 includes one or more former or later examples, wherein the data compression format comprises one or more of: zstandard, LZ77, LZ78, LZ4, DEFLATE, GZIP, XP10, or Snappy.

Example 15 includes one or more former or later examples, and includes a method that includes: performing, by an accelerator, an offloaded data compression operation by: compressing data and generating a compressed data frame consistent with a data compression format comprising a header and footer.

Example 16 includes one or more former or later examples, wherein the generating the compressed data frame comprises generating the compressed data frame in a first format and wherein the first format comprises a literal length, match offset, and match length.

Example 17 includes one or more former or later examples, and includes verifying, by the accelerator, the compressed data prior to identification of the compressed data to a requester of the offloaded data compression operation.

Example 18 includes one or more former or later examples, and includes the accelerator performing: receiving the data to be compressed into a first buffer, generating a first integrity check value on the data in the first buffer, storing the compressed data into a second buffer, generating a second integrity check value on the compressed data in the second buffer, and providing access to the first integrity check and the second integrity check to a requester of the offloaded data compression operation for the requester to verify integrity of the compressed data.

Example 19 includes one or more former or later examples, and includes configuring the accelerator with a size of a buffer to store the compressed data based on a configuration from a requester of the offloaded data compression operation.

Example 20 includes one or more former or later examples, wherein the data compression format comprises one or more of: zstandard, LZ77, LZ78, LZ4, DEFLATE, GZIP, XP10, or Snappy.

1. An apparatus comprising:
an interface and
a circuitry, coupled to the interface, to:
based on receipt of a request from a requester to offload performance of data compression to an accelerator, compress data, generate a header for the compressed data, generate a footer for the compressed data, and generate a compressed data frame consistent with a data compression format comprising the header and footer.

2. The apparatus of claim 1, wherein to compress data, the circuitry is to compress data into a first format and generate the compressed data based on the compressed data in the first format.

3. The apparatus of claim 1, wherein the circuitry is to verify the compressed data prior to identification of compressed data to the requester based on integrity check values.

4. The apparatus of claim 1, wherein the circuitry is to:
receive the data to be compressed into a first buffer,
generate a first integrity check value on the data in the first buffer,
store the compressed data into a second buffer,
generate a second integrity check value on the compressed data in the second buffer, and
provide access to the first integrity check and the second integrity check to the requester for the requester to verify integrity of the compressed data.

5. The apparatus of claim 1, wherein the circuitry is to:
configure a size of a buffer to store the compressed data based on a configuration from the requester.

6. The apparatus of claim 1, wherein the data compression format comprises one or more of: zstandard, LZ77, LZ78, LZ4, DEFLATE, GZIP, XP10, or Snappy.

7. The apparatus of claim 1, wherein the accelerator is accessible by a processor via device interface and wherein the accelerator comprises one or more of: a field programmable gate array (FPGA) or an application specific integrated circuit (ASIC).

8. At least one non-transitory computer-readable medium, comprising instructions stored thereon, that if executed by one or more processors, cause the one or more processors to:
configure an accelerator to:
perform an offloaded data compression operation by: compressing data, generating a header for the compressed data, generating a footer for the compressed data, and generating a compressed data frame consistent with a data compression format comprising the header and footer.

9. The non-transitory computer-readable medium of claim 8, wherein to compress data, the accelerator is to compress data into a first format and generate the compressed data based on the compressed data in the first format.

10. The non-transitory computer-readable medium of claim 9, wherein the first format comprises a literal length, match offset, and match length.

11. The non-transitory computer-readable medium of claim 8, comprising instructions stored thereon, that if executed by one or more processors, cause the one or more processors to:
configure the accelerator to verify the compressed data prior to identification of compressed data to a requester of the offloaded data compression operation.

12. The non-transitory computer-readable medium of claim 8, comprising instructions stored thereon, that if executed by one or more processors, cause the one or more processors to:
configure the accelerator to:
receive the data to be compressed into a first buffer,
generate a first integrity check value on the data in the first buffer,
store the compressed data into a second buffer,
generate a second integrity check value on the compressed data in the second buffer, and provide access to the first integrity check and the second integrity check to a requester of the offloaded data compression operation for the requester to verify integrity of the compressed data.

13. The non-transitory computer-readable medium of claim 8, comprising instructions stored thereon, that if executed by one or more processors, cause the one or more processors to:
configure the accelerator to:
configure a size of a buffer to store the compressed data based on a configuration from a requester of the offloaded data compression operation.

14. The non-transitory computer-readable medium of claim 8, wherein the data compression format comprises one or more of: zstandard, LZ77, LZ78, LZ4, DEFLATE, GZIP, XP10, or Snappy.

15. A method comprising:
performing, by an accelerator, an offloaded data compression operation by: compressing data and generating a compressed data frame consistent with a data compression format comprising a header and footer.

16. The method of claim 15, wherein the generating the compressed data frame comprises generating the compressed data frame in a first format and wherein the first format comprises a literal length, match offset, and match length.

17. The method of claim 16, comprising:
verifying, by the accelerator, the compressed data prior to identification of the compressed data to a requester of the offloaded data compression operation.

18. The method of claim 15, comprising:
the accelerator performing:
receiving the data to be compressed into a first buffer,
generating a first integrity check value on the data in the first buffer,
storing the compressed data into a second buffer,
generating a second integrity check value on the compressed data in the second buffer, and
providing access to the first integrity check and the second integrity check to a requester of the offloaded data compression operation for the requester to verify integrity of the compressed data.

19. The method of claim 15, comprising:
configuring the accelerator with a size of a buffer to store the compressed data based on a configuration from a requester of the offloaded data compression operation.

20. The method of claim 15, wherein the data compression format comprises one or more of: zstandard, LZ77, LZ78, LZ4, DEFLATE, GZIP, XP10, or Snappy.
